(19) United States
(12) Patent Application Publication
(10) Pub. No.: US 2014/0315608 A1
(43) Pub. Date: Oct. 23, 2014

(54) Folding Unload Tube for a Combine

(71) Applicant: Douglas Charles Novlan, Paradise Hill (CA)

(72) Inventor: Douglas Charles Novlan, Paradise Hill (CA)

(21) Appl. No.: 14/166,112

(22) Filed: Jan. 28, 2014

Related U.S. Application Data
(60) Provisional application No. 61/757,402, filed on Jan. 28, 2013.

(51) Int. Cl. A01D 41/12

(52) U.S. Cl. CPC A01D 41/1217
USPC 460/114

(57) ABSTRACT

An unload tube for a combine include an upright lift portion arranged to lift grain therethrough from the onboard grain storage bin and a transfer portion connected to the lift portion by an elbow portion so as to receive grain therefrom. The transfer portion is formed from several sections coupled in series with one another for relative movement between an extended position and a retracted position in which the transfer portion is reduced in length relative to the extended position. The elbow portion is also movable relative to the onboard grain storage bin in the retracted position of the transfer portion between a working position supporting the transfer portion above the upper hopper portion of onboard storage bin and a storage position in which the transfer portion and the elbow portion are lowered downwardly in height relative to the working position.

This application claims the benefit under 35 U.S.C. 119(e) of U.S. provisional application Ser. No. 61/757,402, filed Jan. 28, 2013.

### FIELD OF THE INVENTION

The present invention relates to an unload tube for unloading a combine in which the unload tube is foldable to reduce the length thereof, and more particularly the present invention relates to a combine unload tube which is pivotal above the onboard storage bin of the combine between opposing left and right unloading positions and which can be folded and lowered downwardly in height relative to the onboard storage bin of the combine from the unloading positions to a storage position.

### BACKGROUND

As described in U.S. Pat. No. 6,908,380 by Silver, an agricultural combine is a common and well-known machine for harvesting crop materials which performs the basic functions of reaping crop materials from a crop field, separating the grain from the non-grain crop materials, and discarding the non-grain crop materials back onto the crop field. As further described by Silver, a typical combine includes a crop harvesting apparatus, or header, which reaps ripened crop plants from the crop field and feeds the crop materials to a separating system including a threshing system and sieves to separate the grain from course and fine non-grain materials. The separated grain is then augered upwardly by a bubble-up auger to an onboard grain storage bin having an upper hopper portion at the top of the combine for temporary storage of grain therein. As the combine harvests the crop field, the grain bin periodically becomes filled with grain and must be emptied to allow the combine to proceed. The grain is then transferred from the grain bin to a truck or a grain cart through an unloading auger which transfers the grain laterally to one side of the combine in an unloading position.

As further described in U.S. Pat. No. 6,908,380 by Silver, the unloading auger is a well-known device to those skilled in the art of combines. Most manufacturers of combines have adopted a similar configuration for the unloading auger. In this common configuration, the unloading auger is positioned along the upper side of the combine with the infeed section of the auger located adjacent to the grain bin. The infeed section is pivotally attached to the combine to allow rotation about a nearly vertical axis. A 90 degree elbow connects the infeed section to a long horizontal section. The horizontal section can then rotate in a generally horizontal plane around the infeed end. With this design the unloading auger can be rotated out to a 90 degree angle from the combine to allow unloading into a truck or grain cart. After unloading, the unloading auger is rotated back so that the horizontal section trails towards the rear of the combine with the exit end located near the combine's rear end.

U.S. Pat. No. 8,033,377 by Reimer et al discloses a similar example of a combine with an unload auger which is stored alongside the combine when not in use but is rotated laterally outward to one side of the combine in an unloading position.

In both U.S. Pat. No. 8,033,377 by Reimer et al and U.S. Pat. No. 6,908,380 by Silver, the unload auger can be folded when not in use to reduce the overall length of the auger and thus the overall length of the combine. In both instance however, in the extended position, the unload auger remains below the upper hopper portion of the onboard storage bin in height so as to maintain the overall height of the combine within acceptable limits. The resulting interference between the storage bin and the unload auger however limits the unload auger to a single unload position offset to one side only of the combine. In many instances however, it would be much more desirable to be able to unload the grain to a transfer vehicle on either side while also meeting the need for a low overall storage and transport height of the combine.

### SUMMARY OF THE INVENTION

According to one aspect of the invention there is provided in an agricultural combine having an onboard grain storage bin including an upper hopper portion, an unload tube for unloading material from the onboard grain storage bin, the unload tube comprising:

a lift portion which is generally upright in a working position and arranged to lift grain therethrough from the onboard grain storage bin;

an elbow portion arranged to be connected to the lift portion so as to receive grain therefrom; and

a transfer portion arranged to be connected to the elbow portion so as to receive grain therefrom;

the transfer portion comprising a plurality of sections coupled in series with one another for relative movement between an extended position and a retracted position in which the transfer portion is reduced in length relative to the extended position; and

the elbow portion being movable relative to the onboard grain storage bin in the retracted position of the transfer portion between a working position supporting the transfer portion above the upper hopper portion of onboard storage bin and a storage position in which the transfer portion and the elbow portion are lowered downwardly in height relative to the working position.

In this manner, pivotally supporting the elbow portion about an upright axis relative to the storage bin in the working position permits the transfer portion to be movable with the elbow portion in the extended position between laterally opposed left and right unloading positions. As there is no interference between the transfer portion and the upper hopper portion of the onboard storage bin, the grain can be unloaded to a transfer vehicle positioned on either the left or right sides of the combine for increased flexibility in operation.

Preferably the elbow portion is pivotal relative to the storage bin in the working position about an upright axis such that the transfer portion is movable with the elbow portion in the extended position between laterally opposed left and right unloading positions.

The lift portion may be located within the upper hopper portion of the onboard grain storage bin, and may further be laterally centered between opposing sides of the combine.

Preferably the lift portion includes a lower portion arranged to lift grain from sieves of the combine to the grain storage bin and an upper portion arranged to lift grain from the grain storage bin to the elbow portion.

The elbow portion may be fully recessed below a height of the onboard grain storage bin in the storage position.

Preferably some or all of the transfer portion is received within the upper hopper portion of the onboard grain storage bin in the storage position of the elbow portion.

The elbow portion may be pivotal relative to the onboard grain storage bin about a substantially horizontal axis between the working position and the storage position.

Preferably the lift portion includes a first portion in communication with the grain storage bin and a second portion in communication upwardly from the first portion to the elbow portion in which the second portion being pivotally coupled to the first portion about a substantially horizontal axis about which the elbow portion is pivotal together with the second portion between the working position and the storage position.

The plurality of sections of the transfer portion may be pivotally coupled to one another for relative pivotal movement between the extended position in which the sections are longitudinally aligned with one another and the retracted position in which the sections extend substantially alongside one another so as to be reduced in length relative to the extended position.

Preferably the transfer portion comprises three or more sections and the sections lie in a substantially common plane with one another in the retracted position.

The transfer portion may be pivotal relative to the elbow portion between the working position and the storage position about both a first axis and a second axis in which the first axis is coaxial with an tube axis at an output of the elbow portion and the second axis is a folding axis which is tangential to the output of the elbow portion.

Preferably the transfer portion is pivoted relative to the elbow portion between the working position and the storage position through a range of approximately 90 degrees about second axis.

One embodiment of the invention will now be described in conjunction with the accompanying drawings in which:

### BRIEF DESCRIPTION OF THE DRAWINGS

FIG. 1 is a side elevational view of the unload tube shown on an exemplary combine in an extended position;

FIG. 2 is a side elevational view of the unload tube shown in solid line in the extended position of FIG. 1 and shown in broken line in either one of the two laterally opposed left and right unloading positions;

FIG. 3 is a top plan view of the upper hopper portion of the onboard grain storage bin of the combine showing the unload tube received therein in a retracted position of the transfer portion and in the storage position of the elbow portion;

FIG. 4 is a front elevational view of the unload tube along the line 4-4 of FIG. 3;

FIG. 5 is a side elevational view of the unload tube along the line 5-5 of FIG. 3; and

FIG. 6 is a side elevational view of the unload tube along the line 5-5 of FIG. 3 but with the unload tube shown in the working position of the elbow portion and in the extended position of the transfer portion.

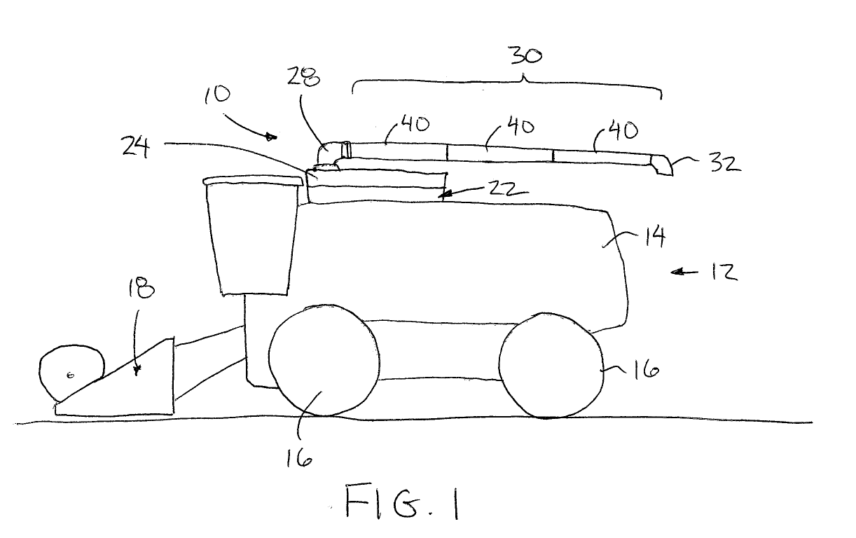

In the drawings like characters of reference indicate corresponding parts in the different figures.

### DETAILED DESCRIPTION

Referring to the accompanying figures, there is illustrated an unload tube generally indicated by reference numeral 10.

The unload tube 10 is particularly suited for use with a combine 12 comprising a frame 14 carried on wheels 16 for movement across the ground in a forward working direction. A header 18 is supported at the front end for feeding material into the combine where a separator system including threshing components and sieves separate the grain from non-grain material. The separated grain is then augered by a lift auger having a lower section 20 communicating from the sieves to an on-board grain storage bin 22. An upper hopper portion 24 of the bin is located at the top end of the combine.

The unload tube 10 is for unloading grain from the on-board grain storage bin to a separate transfer vehicle typically positioned alongside the combine. In the illustrated embodiment, the unload tube is incorporated with the lift auger such that the lift auger defines part of a lift portion of the unload tube.

The unload tube generally comprises the lift portion 26 which vertically lifts the grain up from the storage bin, an elbow portion 28 connected to the lift portion to receive the grain therefrom and a transfer portion 30 connected to the elbow portion to receive the grain therefrom and convey the grain to a discharge chute 32 at the terminal end of the transfer portion.

The lift portion 26 has a lower first section defined by the lower section 20 of the lift auger and an upper section 34 arranged to be connected in series directly above the lower section 20. The upper section extends vertically upward in line with the lower section for continuing to convey the grain upwardly from the storage bin to the elbow portion 28 thereabove. The upper and lower sections are connected in series with one another at a laterally centered location between opposing sides of the combine, within the interior of the storage bin adjacent the front end of the storage bin.

The elbow portion comprises a tubular housing which bends through an angle of 90 degrees between an inlet 36 and an outlet 38 thereof. The inlet is concentric with an inlet auger axis defined by the lift auger when connected thereto in the working position. Similarly, the outlet is concentric with an outlet auger axis defined by the auger of the transfer portion when connected thereto in the working position.

In the illustrated embodiment, the transfer portion comprises three tubular sections 40 rotatably receiving respective auger sections therein and which are arranged to be connected in series with one another so as to be movable relative to one another between respective extended and retracted positions. In further embodiments, more or fewer tubular sections may be used and the tubular sections may convey material therethrough using various known conveying means other than augers specifically.

In the extended position, the three sections extend horizontally from an inlet of the transfer portion connected to the outlet of the elbow portion and an outlet at the discharge chute 32. The three sections in the extended position are connected end to end concentrically with one another and the outlet of the elbow portion in the working position. The transfer portion connects to the elbow in the extended position so as to be movable together with the elbow portion about a vertical axis of the elbow when extended. The extended transfer portion is pivotal about the vertical axis between an intermediate position extending horizontally rearward parallel to the forward direction and either one of two laterally opposed left and right unload positions for unloading from either side of the combine. The transfer portion is rotated about the vertical axis of the lift auger in two opposing directions through a range of 90 degrees in each direction towards the two laterally opposed positions respectively.

To allow pivoting of the transfer portion together with the elbow portion between the left and right unload positions, the elbow portion is pivotally coupled to the lift portion by a rotatable collar 42 at the inlet of the elbow which defines the vertical inlet auger axis.

The elbow portion is also coupled to the upper section of the lift portion so as to be pivotal together with the upper section relative to the lower section about a horizontal folding axis. The folding axis is generally horizontal and tangential to the vertical axis of the lift auger so as to be parallel to the forward working direction. The elbow portion and upper section of the lift portion are pivotal relative to the lower section between the working position in which the elbow portion and the transfer portion connected thereto are supported fully above the top end of the hopper of the storage bin to allow unrestricted pivoting movement between the two unloading positions and the storage position in which the transfer portion is retracted so that the transfer portion and the elbow portion can be fully received within the upper hopper portion of the storage bin below the height of the top end of the hopper portion for reducing the overall height of the combine. In the storage position the elbow portion is folded laterally to one side of the lower section of the lift auger so as to be adjacent one side of the hopper portion of the storage bin while remaining adjacent the front side.

In this manner, the elbow portion is rotated about two axes relative to the lower section of the lift portion between the storage and working positions respectively. These include the first axis defined by rotatable collar 42 so as to coincide with the lift auger axis and the inlet auger axis of the elbow portion and a second axis defined by the tangential folding axis between the upper and lower sections of the lift portion of the unload tube. Between the storage and working positions, the upper section is rotated about the respective axis relative to the lower section through a range of 90 degrees. The elbow portion is rotated about the inlet auger axis relative to the upper section of the lift portion such that the outlet auger axis is oriented rearward parallel to the forward working direction in the storage position.

The three sections of the transfer portion are pivotally coupled relative to one another so that in the retracted position, each section is folded alongside at least one adjacent section about a respective folding axis oriented tangentially to the transfer portion auger housing. The folding axes are all parallel to one another so that the multiple sections of the transfer portion can be folded alongside one another in a generally common plane which reduces the overall length of the transfer portion in the longitudinal direction thereof relative to the extended position.

The transfer portion is coupled at the innermost section to the outlet of the elbow portion about two axes to allow sufficient manipulation of the transfer portion from the extended working position to the retracted storage position. A rotatable collar 44 is supported at the outlet of the elbow portion such that the collar defines a first axis of rotation between the transfer portion and the elbow portion which is concentric with the output auger axis. The second axis is defined by a pivot assembly 46 coupled to the collar for rotation relative to the elbow portion with the collar and transfer portion. The pivot assembly defines the second axis of pivotal movement between the transfer portion and the elbow portion in which the second axis is tangential to the outlet auger axis.

In order to position the unload tube in the storage position, the transfer portion is folded into the retracted position and the elbow portion is pivoted relative to the lower section about its two respective axes from the working position to the storage position which results in all three sections of the transfer portion being fully received within the interior of the hopper portion of the storage bin so as to be oriented generally horizontally in a lateral direction perpendicular to the forward working direction.

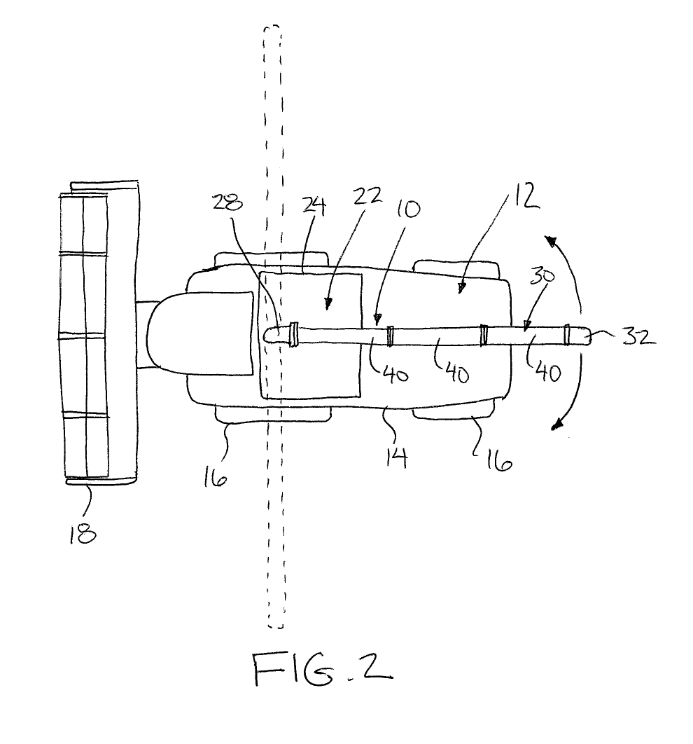

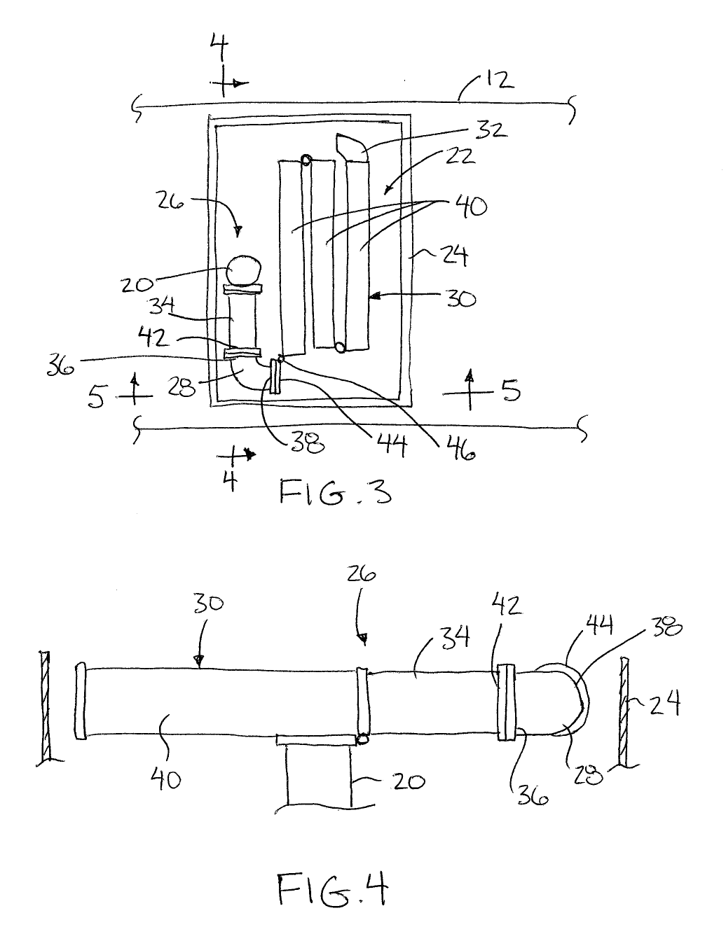

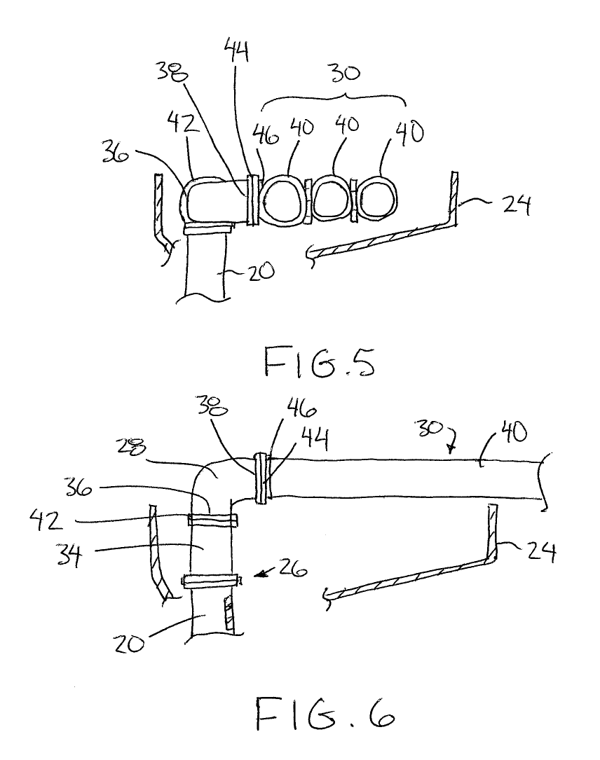

To position the transfer tube into either one of the two unloading positions, the elbow portion is raised into the working position while simultaneously the transfer portion is pivoted relative to the elbow portion to permit the three sections of the transfer portion to be subsequently extended from the retracted position to the extended position. Once the transfer portion is suitably oriented with the discharge auger directed downwardly at the outer end opposite the elbow portion, the transfer portion can be pivoted with the elbow about the upright axis defined by the rotatable collar 42 to position the transfer portion into either one of the two laterally opposed unloading positions shown in FIG. 2,

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. In an agricultural combine having an onboard grain storage bin including an upper hopper portion, an unload tube for unloading material from the onboard grain storage bin, the unload tube comprising:
a lift portion which is generally upright in a working position and arranged to lift grain therethrough from the onboard grain storage bin;
an elbow portion arranged to be connected to the lift portion so as to receive grain therefrom; and
a transfer portion arranged to be connected to the elbow portion so as to receive grain therefrom;
the transfer portion comprising a plurality of sections coupled in series with one another for relative movement between an extended position and a retracted position in which the transfer portion is reduced in length relative to the extended position; and
the elbow portion being movable relative to the onboard grain storage bin in the retracted position of the transfer portion between a working position supporting the transfer portion above the upper hopper portion of onboard storage bin and a storage position in which the transfer portion and the elbow portion are lowered downwardly in height relative to the working position.

2. The unload tube according to claim 1 wherein the elbow portion is pivotal relative to the storage bin in the working position about an upright axis such that the transfer portion is movable with the elbow portion in the extended position between laterally opposed left and right unloading positions.

3. The unload tube according to claim 1 wherein the lift portion is located within the upper hopper portion of the onboard grain storage bin.

4. The unload tube according to claim 1 wherein the lift portion is laterally centered between opposing sides of the combine.

5. The unload tube according to claim 1 wherein the lift portion including a lower portion arranged to lift grain from sieves of the combine to the grain storage bin and an upper portion arranged to lift grain from the grain storage bin to the elbow portion.

6. The unload tube according to claim 1 wherein the elbow portion is fully recessed below a height of the onboard grain storage bin in the storage position.

7. The unload tube according to claim 1 wherein at least a portion of the transfer portion is received within the upper hopper portion of the onboard grain storage bin in the storage position of the elbow portion.

8. The unload tube according to claim 7 wherein the transfer portion is fully received within the onboard grain storage bin in the storage position of the elbow portion.

9. The unload tube according to claim 1 wherein the elbow portion is pivotal relative to the onboard grain storage bin about a substantially horizontal axis between the working position and the storage position.

10. The unload tube according to claim 1 wherein the lift portion includes a first portion in communication with the grain storage bin and a second portion in communication upwardly from the first portion to the elbow portion, the second portion being pivotally coupled to the first portion about a substantially horizontal axis about which the elbow portion is pivotal together with the second portion between the working position and the storage position.

11. The unload tube according to claim 1 wherein the plurality of sections of the transfer portion are pivotally coupled to one another for relative pivotal movement between the extended position in which the sections are longitudinally aligned with one another and the retracted position in which the sections extend substantially alongside one another so as to be reduced in length relative to the extended position.

12. The unload tube according to claim 11 wherein the transfer portion comprises three or more sections and the sections lie in a substantially common plane with one another in the retracted position.

13. The unload tube according to claim 1 wherein the transfer portion is pivotal relative to the elbow portion between the working position and the storage position about both a first axis and a second axis in which the first axis is coaxial with an tube axis at an output of the elbow portion and the second axis is a folding axis which is tangential to the output of the elbow portion.

14. The unload tube according to claim 13 wherein the transfer portion is pivoted relative to the elbow portion between the working position and the storage position through a range of approximately 90 degrees about second axis.
